(19) United States
(12) Patent Application Publication
(10) Pub. No.: US 2018/0327029 A1
(43) Pub. Date: Nov. 15, 2018

(54) DRIVING SUPPORT APPARATUS AND PROGRAM

(71) Applicant: DENSO CORPORATION, Kariya-city, Aichi-pref. (JP)

(72) Inventors: Masao Oooka, Kariya-city, Aichi-pref. (JP); Takahiro Narita, Kariya-city, Aichi-pref. (JP); Kouji Fujiki, Kariya-city, Aichi-pref. (JP)

(73) Assignee: DENSO CORPORATIONJP, Kariya-city, Aich-pref (JP)

(21) Appl. No.: 15/755,913

(22) PCT Filed: Aug. 26, 2016
(86) PCT No.: PCT/JP2016/074951

§ 371 Date: Feb. 27, 2018

(30) Foreign Application Priority Data
Aug. 28, 2015 (JP) 2015-169349

(51) Int. Cl. B62D 15/02; B60Q 9/00

(52) U.S. Cl. CPC B62D 15/0255; B60W 30/18163; B60Q 9/00

(57) ABSTRACT

A driving support apparatus includes: a scheduled change detection section that detects a lane change schedule of a target vehicle; a competition detection section that detects a competing vehicle that is making lane change to the same lane as that to which the target vehicle is making lane change, while competing with the target vehicle, when the scheduled change detection section detects the lane change schedule; and a timing setting section that sets timing of lane change of the target vehicle depending on the competing vehicle when the competition detection section detects the competing vehicle.

### TECHNICAL FIELD

The present invention relates to a driving support apparatus that supports driving a vehicle, and a program.

### BACKGROUND ART

Conventionally, as a driving support apparatus that supports driving a vehicle, for example, an apparatus is proposed which performs automatic steering while recognizing a lane by using a white line recognition sensor, when the driver operates a winker switch to indicate a right-hand direction or a left-hand direction (e.g. refer to Patent Literature 1).

### CITATION LIST

### Patent Literature

[Patent Literature 1] JP-A-2008-94111

### SUMMARY OF THE INVENTION

### Technical Problem

However, the apparatus disclosed in Patent Literature 1 does not consider whether a vehicle is present in the lane to which a vehicle subjected to the driving support will perform lane change. Various driving support apparatuses can be considered to suppress a collision with a vehicle running in the lane that is a target of lane change when the lane change is performed. However, when such an apparatus is simply combined with the apparatus disclosed in Patent Literature 1, the following problem occurs.

For example, a case is present where another vehicle attempts to perform lane change to the same lane to which the own vehicle is attempting to perform lane change. Hence, when lane change is performed, it is required to consider more situations than those considered in other driving supports.

### Solution to Problem

An embodiment provides a technique that can appropriately support lane change of an own vehicle, even in a case where another vehicle attempts to perform lane change to the same lane to which the own vehicle is attempting to perform lane change, while competing with the own vehicle.

A driving support apparatus of an embodiment includes: a scheduled change detection section that detects a lane change schedule of a target vehicle; a competition detection section that detects a competing vehicle that is making lane change to the same lane as that to which the target vehicle is making lane change, while competing with the target vehicle, when the scheduled change detection section detects the lane change schedule; and a timing setting section that sets timing of lane change of the target vehicle depending on the competing vehicle when the competition detection section detects the competing vehicle.

### BRIEF DESCRIPTION OF THE DRAWINGS

FIG. 1 is a block diagram showing a configuration of a driving support apparatus to which the present invention is applied;

FIG. 2 is a flowchart of a driving support process performed by the driving support apparatus;

FIG. 3 is a flowchart of a lane change arbitration process in the driving support process;

FIG. 4 is a flowchart of a lane change priority order determination process in the lane change arbitration process;

FIG. 5 is a diagram illustrating a vehicle behavior to which the driving support process is applied;

FIG. 6 is a diagram illustrating the continuation of the vehicle behavior;

FIG. 7 is a diagram illustrating the further continuation of the vehicle behavior;

FIG. 8 is a diagram illustrating another vehicle behavior to which the driving support process is applied;

FIG. 9 is a diagram illustrating the continuation of the vehicle behavior; and

FIG. 10 is a diagram illustrating the further continuation of the vehicle behavior.

### DESCRIPTION OF THE EMBODIMENTS

Hereinafter, embodiment to which the present invention is applied will be described with reference to the drawings.

### 1. First Embodiment

[1-1. Configuration]

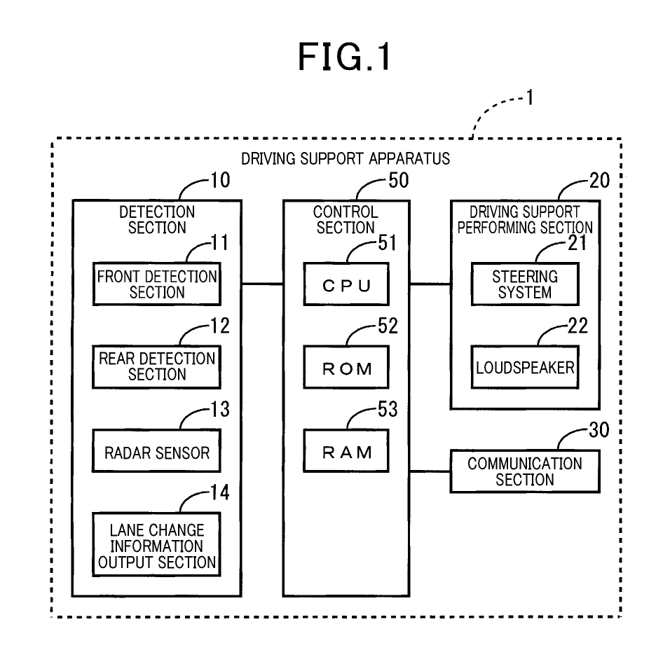

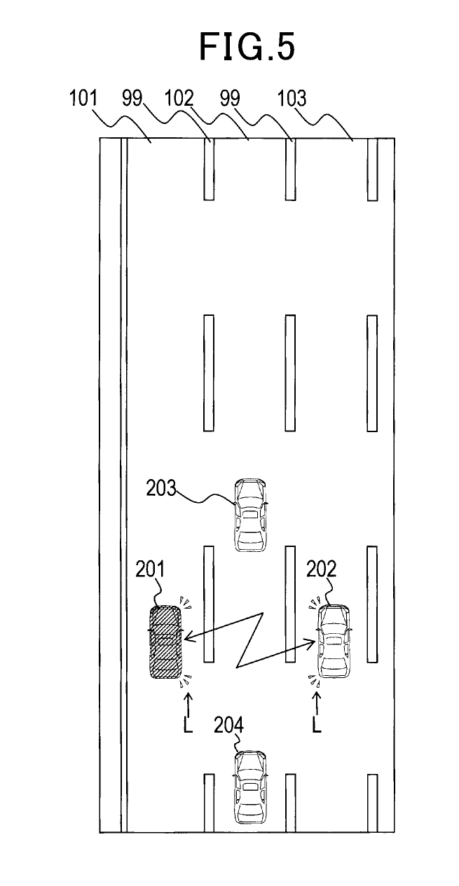

A driving support apparatus 1 shown in FIG. 1 is installed in a vehicle (e.g. vehicles 201, 202 described later: refer to FIG. 5). The driving support apparatus 1 performs driving support for a driving operation, for example, when a vehicle to which the present apparatus is installed (hereinafter, also referred to as an own vehicle) runs on a road having a plurality of lines. The driving operation is lane change from an own lane, in which the own vehicle runs, to an adjacent lane, which is adjacent to the own lane. The driving support apparatus 1 includes a detection section 10, a driving support performing section 20, a communication section 30, and a control section 50.

The detection section 10 can be configured by various detection sections or communication sections other than those shown in FIG. 1. The present embodiment includes, as an example, a front detection section 11, a rear detection section 12, a radar sensor 13, and a lane change information output section 14.

The front detection section 11 detects a border line 99 (refer to FIG. 5) present in the travelling direction and ahead of the own vehicle. The border line 99 divides a line into the own vehicle lane and the adjacent line. It is noted that, in the present embodiment, the front detection section 11 detects, in addition to the border line 99, presence or absence of a front vehicle and an adjacent front vehicle. Here, the front vehicle is a vehicle running ahead of the own vehicle and in the same lane as that in which the own vehicle runs. The adjacent front vehicle is a vehicle running ahead of the own vehicle and in the adjacent lane. It is noted that when the own vehicle runs in a road having three or more lanes on one side, the adjacent front vehicles include a vehicle that runs ahead of the own vehicle and in the lane adjacent to the adjacent lane (not adjacent to the own line).

Specifically, the front detection section 11 includes a camera, which is mounted on the front side of the own vehicle so as to be able to take an image of a front vehicle and an adjacent front vehicle. In the front detection section 11, the camera repeatedly takes images of a scene in front of the own vehicle including the border line 99 (refer to FIG. 5), and outputs image data representing the taken images to the control section 50.

The rear detection section 12 detects a following vehicle and an adjacent rear vehicle present in the direction opposite to the traveling direction of the own vehicle. The following vehicle is a vehicle running behind the own vehicle and in the same line as that in which the own vehicle runs. The adjacent rear vehicle is a vehicle running behind the own vehicle and in the adjacent line. It is noted that when the own vehicle runs in a road having three or more lanes on one side, the adjacent rear vehicles include a vehicle that runs behind the own vehicle and in the lane adjacent to the adjacent lane (not immediately adjacent to the own line).

Specifically, the rear detection section 12 includes a camera as in the front detection section 11. The camera is mounted on the rear side of the own vehicle so as to be able to take an image of a following vehicle and an adjacent rear vehicle. In the rear detection section 12, the camera repeatedly takes images of a scene seen in the direction opposite to the traveling direction of the own vehicle, and outputs image data representing the taken images to the control section 50.

The radar sensor 13 transmits radio waves to the periphery of the own vehicle to detect another vehicle or the like present around the own vehicle based on the result of the reception of reflected waves, and outputs the detection result to the control section 50. Hence, regarding the longitudinal direction of the own vehicle, detection results of the front detection section 11 and the rear detection section 12 can be complemented by the detection result of the radar sensor 13. In addition, regarding the crosswise direction of the own vehicle, the radar sensor 13 can detect a vehicle or the like outside detection ranges of the front detection section 11 and the rear detection section 12. It is noted that, although not shown, the radar sensor 13 may include a millimeter-wave radar and a laser radar. The radar sensor 13 may be configured by a plurality of millimeter-wave radars or laser radars placed at positions in the own vehicle.

The lane change information output section 14 outputs lane change information. The lane change information represents whether or not the own vehicle is required to perform lane change. The lane change information output section 14 includes, although not shown, as an example, a right direction indicator and a left direction indicator disposed at the right side portion and the left side portion of the own vehicle.

For example, when the right direction indicator and the left direction indicator are operated by the driver of the own vehicle in such a case where lane change is performed, the indicators output a signal indicating that the indicators have been operated by the driver. In addition, when the right direction indicator and the left direction indicator are not operated by the driver of the own vehicle, the indicators output a signal indicating that the indicators have not been operated by the driver. The lane change information output section 14 outputs the signals output from the right direction indicator and the left direction indicator to the control section 50 as the lane change information.

It is noted that the lane change information output section 14 may include a car navigation system or an automatic driving system which calculates a lane in which the own vehicle should run. For example, when the lane change information output section 14 includes the automatic driving system, the automatic driving system may give notice that it will perform lane change. When the driver acknowledges the notification, the lane change information output section 14 may output lane change information representing that the lane change will be performed.

The driving support performing section 20 includes a plurality of units for controlling behaviors of controlled objects such as a body system, a power train system, and a chassis system of the own vehicle. The controlled objects include at least a steering system 21 and a loudspeaker 22. Furthermore, a braking unit such as a brake, a driving unit such as an accelerator, a display, an engine, and the like, which are not shown, may be included. The units configuring the driving support performing section 20 may control behaviors of the controlled objects depending on a traveling condition of the vehicle. In addition, the units may control behaviors of the controlled objects according to a command from the control section 50 to perform known vehicle control such as steering control, engine control, and various types of alarm control such as a speed alarm, a rear-end collision alarm, and an inter-vehicle distance alarm. In addition, the units configuring the driving support performing section 20 may detect a condition of the controlled object and output the detection result to the control section 50.

The communication section 30 is a known unit that can perform inter-vehicle communication with at least another vehicle. It is noted that, as described in the later modification, the communication section 30 may be configured to be able to communicate with a traffic management center or the like.

The control section 50 includes a known microcomputer having a CPU 51, a ROM 52, a RAM 53, and the like. The CPU 51 performs various processes based on a program stored in a recording medium such as the ROM 52 to control the driving support apparatus 1.

[1-2. Process]

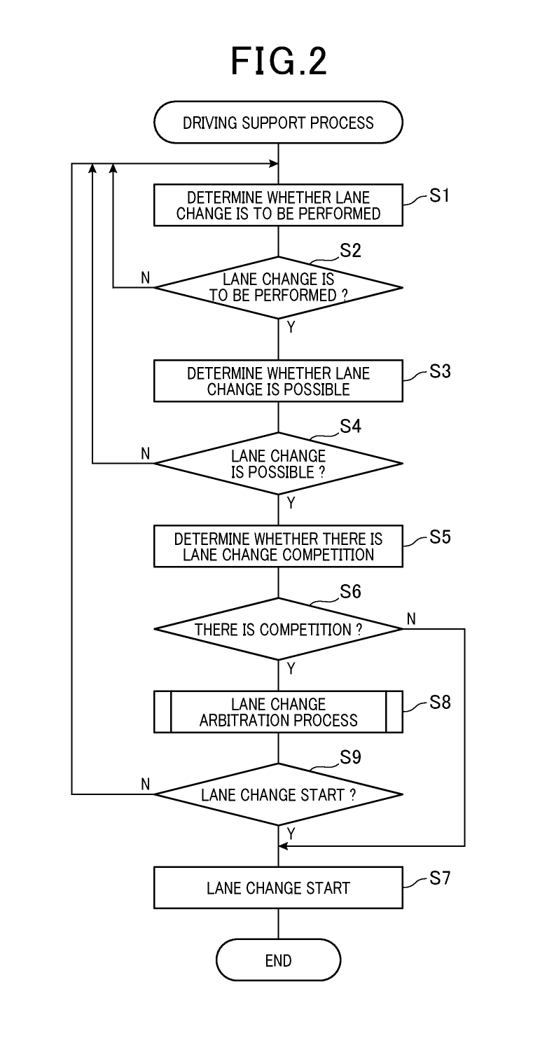

Next, a driving support process concerning lane change performed by the control section 50 will be described with reference to the flowchart shown in FIG. 2. It is noted that this process is repeatedly performed at predetermined time intervals by the CPU 51 based on the program stored in the ROM 52, after power of the own vehicle is turned on.

As shown in FIG. 2, in this process, first in S1 (S indicates step: and so on), the CPU 51 determines whether or not lane change of the own vehicle is to be performed, based on the lane change information output from the lane change information output section 14. Next, in succeeding S2, the CPU 51 determines whether or not the lane change of the own vehicle is to be performed, based on the determination result of S1. If the lane change is not to be performed (S2; N), the process proceeds to the above S1. In contrast, if the lane change is to be performed (S2; Y), the process proceeds to S3, in which the CPU 51 determines whether or not the lane change is possible, based on the detection result of the radar sensor 13 or the like.

In the S3, for example, it is determined whether or not the own vehicle can safely make lane change to the adjacent lane, based on, for example, whether the adjacent lane, to which the own vehicle make lane change, has an entry feasible area where the own vehicle can enter, or how the entry feasible area has changed due to a behavior of another vehicle. It is noted that the behavior of the other vehicle may include the change of the entry feasible area caused by acceleration and deceleration of a vehicle that has been running in the adjacent lane from the beginning, and a behavior of a vehicle (hereinafter, also referred to as competing vehicle) that is making lane change to the same area of the same lane as that to which the own vehicle is making lane change, while competing with the own vehicle. In the proceeding S4, the CPU 51 determines whether or not the determination result of S3 indicates that the lane change is possible. If the lane change is not possible (S4: N), the process proceeds to the above S1. In contrast, if the lane change is possible (S4: Y), the process proceeds to S5.

In the S5, the CPU 51 determines whether or not there is a competing vehicle (competitive vehicle). It is noted that this determination may be made based on a condition of the direction indicators (so-called winkers) of the adjacent front vehicle and the adjacent rear vehicle whose images are taken by the front detection section 11 and the rear detection section 12, the positions of the vehicles, or the like, or may be made through inter-vehicle communication via the communication section 30. In the succeeding S6, the CPU 51 determines whether or not the determination result of S5 indicates that there is a competing vehicle. If there is no competing vehicle (S6: N), the process proceeds to S7 in which the lane change is started. In the S7, the control for making the own vehicle perform lane change depending on the lane change information by known automatic steering control or the like is started in another routine, and the process halts.

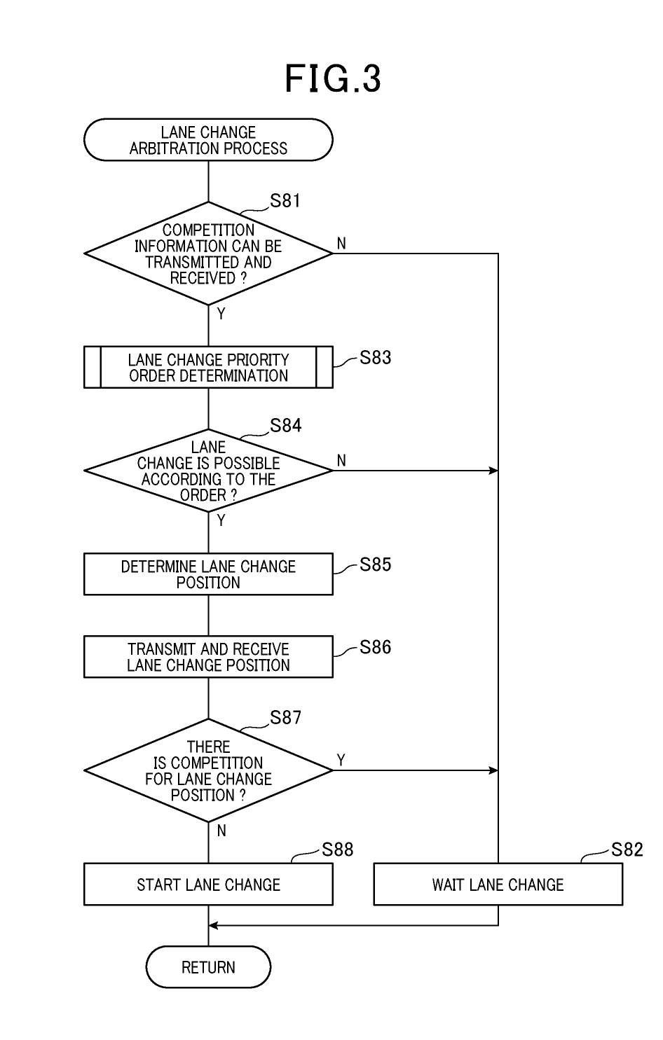

In contrast, if it is determined that there is a competing vehicle in S6 (S6: Y), the process proceeds to S8. In S8, the lane change arbitration process shown in FIG. 3 in detail is performed. As shown in FIG. 3, in this process, first in S81, the CPU 51 determines whether or not various types of information (hereinafter, also referred to as competition information) for arbitrating the competition can be transmitted to and received from the competing vehicle. If the competition information cannot by transmitted and received (S81: N), the process proceeds to S82, in which a wait for the lane change is instructed. Then, the process proceeds to S9 in FIG. 2.

In S9, according to the lane change arbitration process in S8 (i.e. FIG. 3), the CPU 51 determines whether or not the start of the lane change is instructed. As described above, when a wait for the lane change is instructed in S82, since the start of the lane change has not been instructed (S9: N), the process proceeds to the above S1. Hence, when the competing vehicle is a general vehicle that does not include an inter-vehicle communication function, negative determinations are always made in S81 and S9, and the start of the lane change in S7 is not performed. It is noted that even in this case, lane change can be performed by manual operation of the driver.

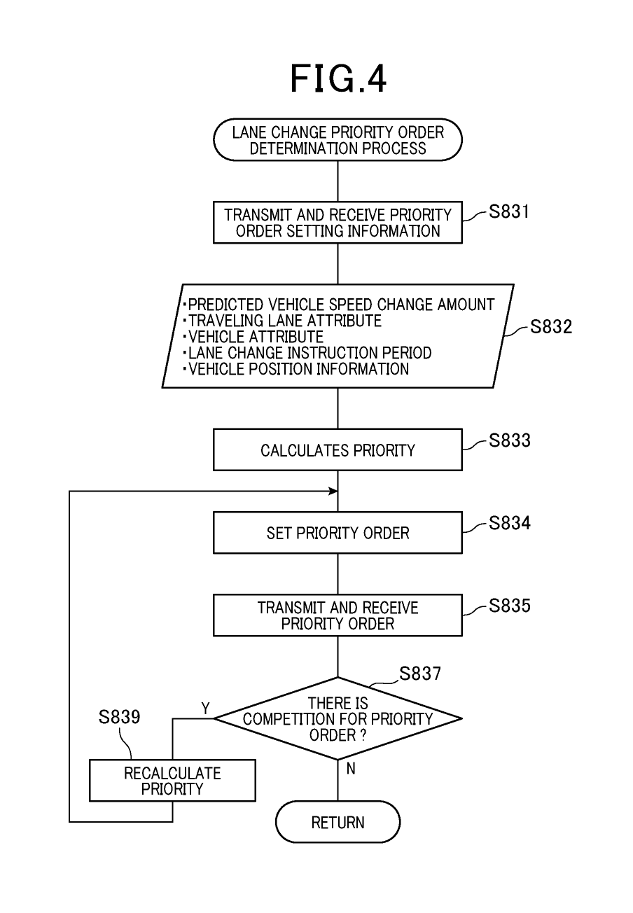

In contrast, if it is determined that the competition information can be transmitted and received (S81: Y), the process proceeds to S83, in which a lane change priority order determination process shown in FIG. 4 in detail is performed.

As shown in FIG. 4, in this process, first in S831, priority order setting information, which is an example of the competition information, is transmitted and received. The priority order setting information includes a predicted vehicle speed change amount, a traveling lane attribute (an example of an attribute of a lane), a vehicle attribute, lane change instruction period, vehicle position information, and the like. The predicted vehicle speed change amount is a predicted value of a vehicle speed change amount obtained when the competing vehicle has not performed lane change. The traveling lane attribute is information on whether or not the lane in which the competing vehicle is running is a passing lane or a travelling lane, whether the lane in which the competing vehicle is running is a lane in which the competing vehicle cannot continue to run in a straight line due to a decrease in the number of lanes or road construction, or the like. The vehicle attribute is information on whether or not the competing vehicle is an emergency vehicle, the grade of the emergency vehicle, a violation history of the competing vehicle, billing information of the competing vehicle, or the like. It is noted that the vehicle attribute may include information such as fuel consumption of the present vehicle. The vehicle position information is position information of the competing vehicle.

In proceeding S832, the CPU 51 reads the above various types of priority order setting information transmitted and received in S831. In S833, the CPU 51 calculates priorities of the competing vehicle and the own vehicle according to the information. In this calculation, a comprehensive priority may be calculated by applying each of the various types of priority order setting information to a map and reading priorities corresponding to respective pieces of information to sum the priorities.

For example, when the information on the time when the direction indicator is turned on is included as the lane change instruction period, the map may be constructed so that as the time is earlier, the priority is higher. In addition, when the grade of the vehicle is included as the vehicle attribute, the map may be constructed so that as the vehicle is higher class, the priority is higher. In addition, when the information on whether or not the vehicle is a member of a paid club or the like allowing vehicles to run preferentially is included as the billing information of the vehicle attribute, the map may be constructed so that such a vehicle that is a member of a paid club has higher priority.

In the subsequent S834, the CPU sets a priority order of the competing vehicle and the own vehicle depending on the priorities calculated in S833. The set priority order is transmitted to or received from the competing vehicle in S835. It is noted that two or more competing vehicles may be provided. In S835, regardless of the number of the competing vehicles, the priority order is transmitted and received by inter-vehicle communication via the communication section 30.

In the succeeding S837, the CPU 51 determines whether or not the priority order calculated at the competing vehicle side and the priority order calculated in the own vehicle compete with each other, based on the result of the transmission and the reception of S835. If they compete with each other (S837: Y), in S839, the CPU 51 calculates a priority again, and the process proceeds to the above S834. In the recalculation in S839, a correction is made in which the priority of the information that differs between the competing vehicle and the own vehicle determinately is raised, to avoid the competition. For example, the correction is made in which the priority of the vehicle running in the passing lane is raised so as to be higher than that of the vehicle running in the traveling lane, the priority of the vehicle running is a lane in which the vehicle cannot continue to run in a straight line is raised, or the priority of a forward vehicle is raised when the competing vehicle and the own vehicle are in the same lane.

Thus, if the competition for the priority order is cancelled, or if there is no competition for the priority order when the process has proceeded to S837 first (in both the cases, S837: N), the process proceeds to S84 in FIG. 3. In S84, the CPU 51 determines whether or not the own vehicle can perform lane change according to the priority order calculated in the process in S83. If the priority order of the own vehicle is higher than those of all the competing vehicles, the lane change can be performed according to the priority order in most cases. However, when there is a sufficient entry feasible area in the adjacent lane to which the own vehicle perform the lane change, the lane change may be possible even when the priority order of the own vehicle is the second or the like. Then, if the lane change is not possible according to the priority order (S84: N), the process proceeds to the above S82, in which a wait for lane change is instructed. If the lane change is possible according to the priority order (S84: Y), the process proceeds to S85.

In S85, the CPU 51 determines an entry position of the own vehicle in the entry feasible area, that is, a lane change position. In the succeeding S86, the determined lane change position is transmitted and received between the own vehicle and the competing vehicle by inter-vehicle communication through the communication section 30. In S87, the CPU 51 determines whether or not there is competition for the lane change position. If there is competition for the lane change position (S87: Y), the process proceeds to the above S82, in which a wait for lane change is instructed. If there is no competition for the lane change position (S87: N), the process proceeds to S88. In S88, a start of lane change is instructed, then the process proceeds to the above S9 (FIG. 2).

Then, in S9, since the start of lane change is indicated in S88, a positive determination is made, and the process proceeds to the above S7. Then, in S7, the control for making the own vehicle lane change to the lane change position determined in S85 is started in another routine, and the process halts.

[1-3. Example of Behavior of Vehicle in the Process]

With the performance of the driving support process described above, the own vehicle behaves, for example, as below. In the example shown in FIG. 5, the driving support apparatus 1 is installed in both vehicles 201 and 202. The vehicles 201 and 202 are running on a road having three lanes on one side, the road being divided into a first traveling lane 101, a second traveling lane 102, and a passing lane 103 by the border lines 99. The vehicle 201 is attempting to perform lane change from the first traveling lane 101 to the second traveling lane 102 (S2: Y). The vehicle 202 is attempting to perform lane change from the passing lane 103 to the second traveling lane 102 (S2: Y). That is, when the vehicle 201 is assumed to be a target vehicle or the own vehicle, the vehicle 202 is a competing vehicle. When the vehicle 202 is assumed to be a target vehicle or the own vehicle, the vehicle 201 is a competing vehicle.

The vehicle 201 is emitting light L of the direction indicator rightward. In addition, the vehicle 202 is emitting light L of the direction indicator leftward. Hence, the vehicles 201 and 202 can recognize that they are competing vehicles mutually (S6: Y).

In addition, in the second traveling lane 102, two vehicles 203 and 204 are running, and an entry feasible area that one vehicle can enter is present between the two vehicles (S4: Y). Hence, in this case, the lane change arbitration process in S8 is performed. It is noted that, in this process, the vehicles 201 and 202 can mutually perform inter-vehicle communication through the communication section 30.

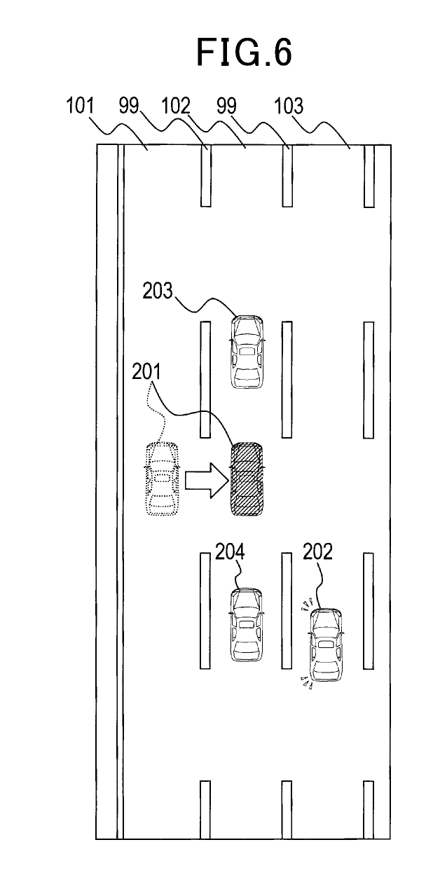

Accordingly, in this case, the CPU 51 determines which is higher the priority order of the vehicle 201 or vehicle 202 (S83). Then, if it is determined that the priority order of the vehicle 201 is higher, and the determination result is common to the driving support apparatuses 1 of the vehicles 201 and 202 (S837: N), a start of lane change is instructed in the vehicle 201 (S88) after the processes of S84 to S87. Then, as shown in FIG. 6, the vehicle 201 performs lane change to the entry feasible area between the vehicles 203 and 204 (S7).

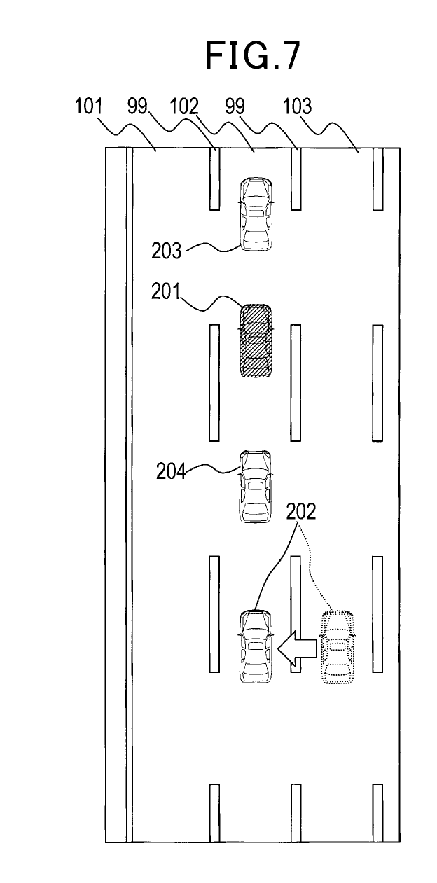

Since only one vehicle can enter the entry feasible area, the vehicle 202 whose priority order is determined to be lower is instructed to wait to perform lane change (S84: N, S82). Hence, as shown in FIG. 7, the vehicle 202 waits until next lane change becomes possible (S4: N), and performs lane change to the position behind the vehicle 204.

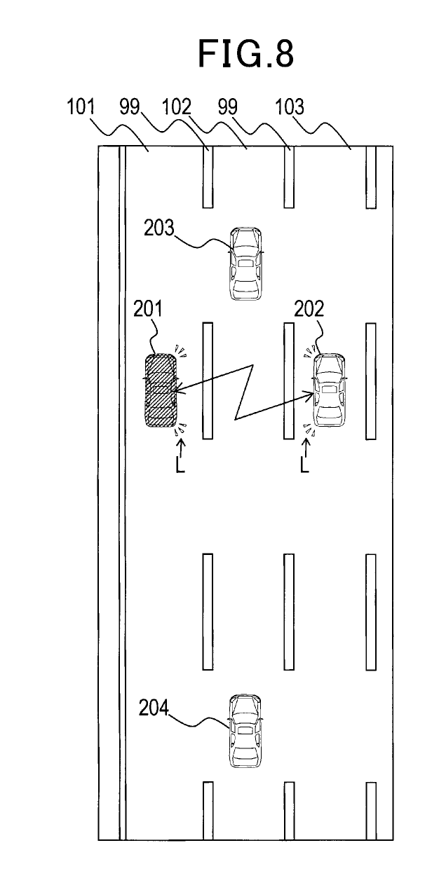

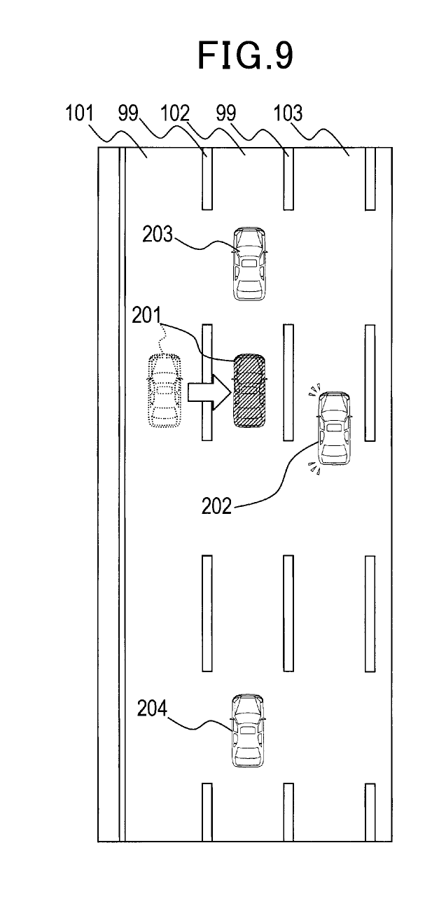

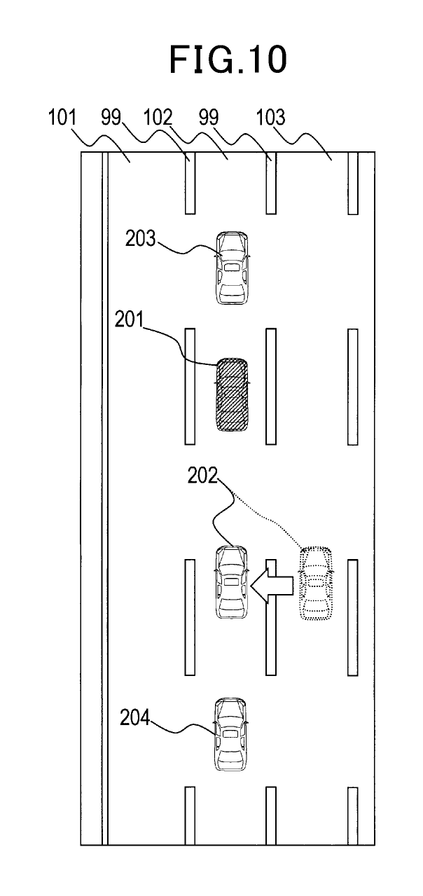

FIG. 8 shows a case where an entry feasible area to which two vehicles can enter is present between the vehicles 203 and 204 (S4: Y). In this case, as described above, if it is determined that the priority order of the vehicle 201 is higher, and the determination result is common to the driving support apparatuses 1 of the vehicles 201 and 202 (S837: N), the lane change position of the vehicle 201 is determined to be ahead of the lane change position of the vehicle 202 (S85). Then, if the determination of the lane change position is common to the driving support apparatuses 1 of the vehicles 201 and 202 (S837: N), each of the vehicles 201 and 202 instructs a start of lane change to the lane change position (S88). Then, as shown in FIG. 9 and FIG. 10, the vehicles 201 and 202 perform lane change to the entry feasible area between the vehicles 203 and 204 so that the vehicle 201 is ahead of the vehicle 202 (S7).

[1-4. Effects]

According to the driving support apparatus 1 of the first embodiment described above in detail, the following effects can be obtained.

[1A] When a competing vehicle that is making lane change to the same lane as that to which the own vehicle (an example of a target vehicle) is making lane change, while competing with the own vehicle (S6: Y), lane change of the own vehicle is performed at the timing set in the processes in S3, S4, S8, S9 depending on the competing vehicle. Hence, even in a case where another vehicle attempts to perform lane change to the same lane to which the own vehicle is attempting to perform lane change, while competing with the own vehicle, the driving support apparatus 1 can appropriately support the lane change of the own vehicle.

[1B] The driving support apparatus 1 sets the timing of the lane change depending on safety of the lane change by the processes in S3 and S4, and sets the timing of the lane change depending on the priority order with respect to the competing vehicle by the processes in S8 and S9. Hence, while the priority order with respect to the competing vehicle is appropriately maintained, and safety is ensured, the lane change of the own vehicle can be supported.

[1C] Furthermore, since the priority order is determined according to the various types of priority order setting information described above (S83), the driving support apparatus 1 can set the priority order of the competing vehicle and own vehicle singularly appropriately.

[1D] Additionally, the determined priority order is shared with the competing vehicle via communication with the competing vehicle (S835). In addition, the priority orders determined in the vehicles are adjusted so as not to compete with each other (S837, S839). Hence, the driving support apparatus 1 can set the priority order of the competing vehicle and the own vehicle more appropriately, and can more favorably prevent a collision between the own vehicle and the competing vehicle by sharing the priority order between the competing vehicle and the own vehicle.

[1E] The driving support apparatus 1 determines whether or not lane change to the adjacent lane is possible based on whether the adjacent lane, to which the own vehicle make lane change, has an entry feasible area where the own vehicle can enter, or how the entry feasible area is changing due to a behavior of another vehicle (S3, S4). It is noted that the behavior of another vehicle includes the change of the entry feasible area caused by acceleration and deceleration of a vehicle that has been running in the adjacent lane from the beginning, and a behavior of the competing vehicle. Hence, a collision between the own vehicle and another vehicle can be prevented more favorably when lane change is performed.

[1F] After the lane change position (an example of timing) is determined (S85), the driving support apparatus 1 shares the lane change position via communication with the competing vehicle (S86, S87). Hence, the driving support apparatus 1 can share the lane change position between the competing vehicle and the own vehicle and prevent the competition for the lane change positions determined in the vehicles, whereby a collision between the own vehicle and the competing vehicle can be prevented more favorably.

[1G] The driving support apparatus 1 can detect whether there is a competing vehicle through inter-vehicle communication via the communication section 30. Hence, compared with a case where a competing vehicle is detected based on only images taken by a camera or the like, omission of detection of the competing vehicle can be prevented.

It is noted that, in the above embodiment, the lane change information output section 14 corresponds to one example of a scheduled change detection section. The control section 50 corresponds to one example of a competition detection section, a timing setting section, and a priority order determination section. The communication section 30 corresponds to one example of an order communication section and a timing communication section. In addition, of the processes performed by the control section 50, S5 and S6 correspond to one example of a competition detection section and a competition detection step, S3, S4, S8, and S9 correspond to one example of a timing setting section and a timing setting step, and S83 corresponds to one example of a priority order determination section.

### 2. Other Embodiments

Hereinbefore, an embodiment of the present invention has been described. However, the present invention is not limited to the embodiment and can be variously embodied.

[2A] In the above embodiment, when the timing of lane change is reached (S6: N, or S9: Y), the lane change is started by automatic steering control. However, this is not a limitation. For example, steering operation (an example of lane change operation) may be only prompted to the driver via the loudspeaker 22 (an example of an audio output unit). The steering operation may be prompted by using at least one of another audio output unit, a video display unit, a reaction force unit of an operating unit. It is noted that, as the audio output unit, in addition to the above loudspeaker 22, a unit outputting various sounds such as a ring or a buzzer can be employed. In addition, as the video display unit, a unit performing various displays such as a liquid crystal display of the car navigation system, or a head-up display can be employed. As the reaction force unit of the operating unit, known various reaction force units applying reaction force to a steering wheel or another operating unit can be employed.

[2B] In the above embodiment, the confirmation of presence or absence of competition for the priority order in S835 and S837 and the confirmation of presence or absence of competition for the lane change position in S86 and S87 are done through inter-vehicle communication via the communication section 30. However, this is not a limitation. For example, when the communication sections 30 of the own vehicle and the competing vehicle can communicate with a center such as a road traffic management center, the confirmation may be done through communication with the center. In addition, in this case, the lane change priority order determination process in S83 and the like may be performed in the center. In this case, by considering, in the center, presence or absence of such a situation that fuel consumption certainly decreases because a line of vehicles is present ahead of the own vehicle or the competing vehicle, the fuel consumption (e.g. catalog value) of the own vehicle and the competing vehicle, or the like, the priority order may be set so that the total fuel consumption of all the vehicles improves.

In addition, when a center is involved, the center may obtain information on presence or absence of the competing vehicle, the positional relationship between the own vehicle and the competing vehicle, and the like, and the vehicle may only receive a signal representing whether or not lane change is possible from the center. In this case, a mobile terminal such as a smartphone may be used as a unit on the vehicle side. In this case, position information of the mobile terminal detected by itself, the vehicle attribute that is previously registered in the mobile terminal, and the like may be transmitted to the center. Based on them, the information on whether lane change is possible calculated on the center side may be received by the mobile terminal.

That is, the configuration of the driving support apparatus of the present invention is not limited to that of an in-vehicle apparatus as in the above embodiment. The driving support apparatus may be configured as a system including a center and an in-vehicle apparatus or a system including a center and a mobile terminal.

[2C] In the above embodiment, if the own vehicle can perform lane change to a specific position (S84: Y), a position is set as the timing of the lane change. In another case concerning safety (S4: N or S84: N), a period (or time) is set (i.e. changed) as the timing of the lane change. However, this is not a limitation. For example, in S85, the timing of lane change may be set as a lane change start time. If a negative determination is made in S4, the position at which lane change is possible may be retrieved to set a lane change position as the timing of lane change. As a matter of course, as the timing of lane change, only a position may be set, or only a period or time may be set.

[2D] In the above embodiment, the timing of lane change is set depending on safety of the lane change by the processes in S3 and S4, and the timing of the lane change is set depending on the priority order with respect to the competing vehicle in S8 and S9. However, this is not a limitation. Only one of the timing setting for lane change depending on safety or the timing setting for lane change depending on the priority order may be performed. The timing setting for lane change may be performed depending on the competing vehicle by another method.

[2E] The function of one component in the above embodiment may be distributed to a plurality of components, or the functions of the plurality of components may be integrated into one component. In addition, some of the configurations of the above embodiment may be omitted. Further, at least some of the configurations of the above embodiment may be replaced with or added to another embodiment. It is noted that the embodiments of the present invention correspond to various aspects encompassed within the technical idea specified only by the wording of the claims.

[2F] The present invention can be achieved by, in addition to the driving support apparatus described above, various aspects such as a system including the driving support apparatus as a component, a program allowing a computer to function as the driving support apparatus, a recording medium that stores the program, and a driving support method. When the present invention is achieved as a program, the program is not necessarily stored in a ROM and used as described above, and may be stored in various recoding mediums such as a flexible disk, a USB memory, and a flash memory, and be used.

The driving support apparatus of the embodiment includes a scheduled change detection section (14), a competition detection section (50, S5, S6), and a timing setting section (50, S3, S4, S8, S9). The scheduled change detection section detects a lane change schedule of a target vehicle. The competition detection section detects a competing vehicle that is making lane change to the same lane as that to which the target vehicle is making lane change, while competing with the target vehicle, when the scheduled change detection section detects the lane change schedule. The timing setting section sets timing of lane change of the target vehicle depending on the competing vehicle when the competition detection section detects the competing vehicle. It is noted that the timing may be a start period or start time of the lane change or the position to which the lane change is performed.

According to the above driving support apparatus, when a competing vehicle that is making lane change to the same lane as that to which the own vehicle is making lane change is detected by the competition detection section, the target vehicle can perform lane change at the timing of lane change set by the timing setting section depending on the competing vehicle. Hence, for example, even in a case where another vehicle attempts to perform lane change to the same lane to which the target vehicle, which is the own vehicle, is attempting to perform lane change, while competing with the own vehicle, the driving support apparatus can appropriately support the lane change of the target vehicle.

It is noted that the driving support apparatus may further include a priority order determination section (50, S83) that determines a priority order concerning lane change of the target vehicle and the competing vehicle. The timing setting section (50, S8, S9) may set the timing depending on at least the priority order determined by the priority order determination section.

When the target vehicle and the competing vehicle use the respective driving support apparatuses that can perform driving support for lane change as described above, each of the driving support apparatuses may cancel the lane change to avoid a collision between the vehicles. In this case, although there is a sufficient entry feasible area in the lane to which the lane change is performed, a situation may occur in which the own vehicle and another vehicle cannot perform the lane change.

However, as described above, since the priority order determination section is provided which determines a priority order concerning lane change of the target vehicle and the competing vehicle, and the timing is set depending on the priority order determined by the priority order determination section, the occurrence of such a situation can be favorably prevented.

It is noted that the bracketed reference sign in this column or in the claims indicates a correspondence relationship with a specific means in the embodiment described as an aspect, and does not limit the technical scope of the present invention. In addition, the present invention can be achieved in various aspects such as, in addition to the driving support apparatus described above, a program executed by a computer, and a driving support method.

### REFERENCE SIGNS LIST

1 . . . driving support apparatus, 11 . . . front detection section, 12 . . . rear detection section, 13 . . . radar sensor, 14 . . . lane change information output section, 21 . . . steering system, 22 . . . loudspeaker, 30 . . . communication section, 50 . . . control section, 101 . . . first traveling lane, 102 . . . second traveling lane, 103 . . . passing lane,
201, 202, 203, 204 . . . vehicle

1. A driving support apparatus characterized by comprising:
a scheduled change detection section (14) that detects a lane change schedule of a target vehicle;
a competition detection section (50, S5, S6) that detects a competing vehicle that is making lane change to the same lane as that to which the target vehicle is making lane change, while competing with the target vehicle, when the scheduled change detection section detects the lane change schedule; and
a timing setting section (50, S3, S4, S8, S9) that sets timing of lane change of the target vehicle depending on the competing vehicle when the competition detection section detects the competing vehicle.

2. The driving support apparatus according to claim 1 characterized in that the timing setting section sets the timing depending on at least one of safety of lane change of the target vehicle and a priority order of lane change of the target vehicle and the competing vehicle.

3. The driving support apparatus according to claim 2 characterized by further comprising a priority order determination section (50, S83) that determines the priority order, wherein
the timing setting section (50, S8, S9) sets the timing depending on at least the priority order determined by the priority order determination section.

4. The driving support apparatus according to claim 3 characterized in that the priority order determination section determines the priority order depending on at least one of running speeds of the target vehicle and the competing vehicle, attributes of lanes in which the target vehicle and the competing vehicle are running, fuel consumption of the target vehicle and the competing vehicle, periods when the target vehicle and the competing vehicle instruct lane change, vehicle attributes of the target vehicle and the competing vehicle, and a positional relationship between the own vehicle and the competing vehicle.

5. The driving support apparatus according to claim 3 or 4 characterized by further comprising an order communication section (30) that makes the target vehicle and the competing vehicle share the priority order determined by the priority order determination section with each other via communication.

6. The driving support apparatus according to any one of claims 2 to 5 characterized in that the timing setting section sets the timing depending on at least one of change of an entry feasible area of the target vehicle in a lane to which the target vehicle performs lane change, and lane change behavior.

7. The driving support apparatus according to any one of claims 1 to 5 characterized in that the timing setting section is provided in the target vehicle and communicates with a center provided outside the target vehicle to set the timing.

8. The driving support apparatus according to any one of claims 1 to 7 characterized in that the competition detection section detects the competing vehicle via communication with another vehicle running around the target vehicle.

9. The driving support apparatus according to any one of claims 1 to 8 characterized by further comprising a timing communication section (30) that makes the target vehicle and the competing vehicle share the timing set by the timing setting section with each other via communication.

10. The driving support apparatus according to any one of claims 1 to 9 characterized by comprising at least one on a video display unit, an audio output unit (22), and a reaction force unit of an operating unit to prompt a driver to perform lane change operation at the timing set by the timing communication section.

11. A program executed by a computer characterized by allowing the computer to perform:
a competition detection step (S5, S6) of detecting a competing vehicle that is making lane change to the same lane as that to which a target vehicle is making lane change, while competing with the target vehicle, when a lane change schedule of the target vehicle is detected, and
a timing setting step (S3, S4, S8, S9) of setting timing of lane change of the target vehicle depending on the competing vehicle when the competing vehicle is detected in the competition detection step.
